(19) United States
(12) Patent Application Publication
(10) Pub. No.: US 2026/0343311 A1
(43) Pub. Date: Oct. 29, 2026

(54) CONTROL PACKET TRANSMISSION SYSTEM, CONTROL PACKET TRANSMISSION METHOD, AND CONTROL PACKET TRANSMISSION PROGRAM

(71) Applicant: NATIONAL INSTITUTE OF INFORMATION AND COMMUNICATIONS TECHNOLOGY, Koganei-shi, Tokyo (JP)

(72) Inventors: Hikaru KAWASAKI, Tokyo (JP); Kazuo IBUKA, Tokyo (JP); Homare MURAKAMI, Tokyo (JP); Takeshi MATSUMURA, Tokyo (JP)

(73) Assignee: NATIONAL INSTITUTE OF INFORMATION AND COMMUNICATIONS TECHNOLOGY, Koganei-shi, Tokyo (JP)

(21) Appl. No.: 19/118,910

(22) PCT Filed: Sep. 11, 2023
(86) PCT No.: PCT/JP2023/033055

§ 371 Date: Apr. 7, 2025

(30) Foreign Application Priority Data
Oct. 11, 2022 (JP) 2022-163256

(51) Int. Cl. H04W 28/02; H04L 69/16

(52) U.S. Cl. CPC H04W 28/0252; H04L 69/16

(57) ABSTRACT

A control packet transmission system mutually transmits a control packet between a request side device and a response side device configuring a client server system that performs wireless communication using MP-TCP via a plurality of wireless communication paths. The control packet transmission system includes the request side device that transmits a plurality of first request packets indicative of a request to the response side device to the response side device via at least one or more wireless communication paths, and the response side device that transmits a plurality of first response packets indicative of a response to the first request packet to the request side device via at least one or more wireless communication paths when the first request packet transmitted by the request side device is received for the first time.

### TECHNICAL FIELD

The present invention relates to a control packet transmission system, a control packet transmission method, and a control packet transmission program.

### BACKGROUND ART

Conventionally, Transmission Control Protocol (TCP) is often used as a protocol used to achieve communication with high reliability. However, TCP has had a problem that it can use only one communication line at a time, and thus has had a problem that the communication speed and the reliability of communication are likely to depend on the performance of the communication line.

Therefore, there has been proposed a method referred to as Multi Path-Transmission Control Protocol (MP-TCP) disclosed in Non-Patent Document 1. MP-TCP is a transport layer technique that performs data transmission using a communication link by a plurality of network interfaces. MP-TCP has been reported to be effective not only in a wired environment, such as a data center, but also in a wireless environment in recent years, and is already supported by iOS, attracting increasing attention. For example, mobile communication devices, such as smartphones, are generally provided with a plurality of network interfaces (for example, Wireless Fidelity (WiFi) (registered trademark), cellular, and the like), and it is expected that interfaces for Beyond 5G systems will be further added in the years to come.

Thus, it is considered that the role to be played by MP-TCP in the communication field (in particular, in mobile communications) will become more and more prominent.
Non-Patent Document 1: TCP Extensions for Multipath Operation with Multiple Addresses, IETF, RFC 8684. (https://www.rfc-editor.org/info/rfc8684)

### DISCLOSURE OF THE INVENTION

### Problems to be Solved by the Invention

Here, in MP-TCP, it is a concern that a serious performance deterioration from the viewpoint of the throughput, reliability, and latency of wireless communication is caused by the loss or arrival delay of transmitted control packets due to effects of, for example, fading that may occur in the wireless communication.

Therefore, the present invention has been made in consideration of the above-described problems, and an object of the present invention is to provide a control packet transmission system, a control packet transmission method, and a control packet transmission program that allows achieving improvement in throughput while ensuring the reliability of communication by MP-TCP.

### Solutions to the Problems

A control packet transmission system according to a first invention mutually transmits a control packet storing control information between a request side device that requests control and a response side device that responds to a control request from the request side device. The request side device and the response side device configure a client server system that performs wireless communication via a wireless communication path and uses Multi Path-Transmission Control Protocol (MP-TCP).

The control packet transmission system includes: the request side device that transmits a plurality of first request packets indicative of a request to the response side device in the control packet to the response side device via at least one or more of the wireless communication paths; and the response side device that transmits a plurality of first response packets indicative of a response to the first request packet in the control packet to the request side device via at least one or more of the wireless communication paths when the first request packet transmitted by the request side device is received for the first time.

In the control packet transmission system according to a second invention, which is in the first invention, the request side device transmits the plurality of first request packets indicative of a request for connection or disconnection to the response side device in the control packet to the response side device via at least two or more of the wireless communication paths. The response side device transmits the plurality of first response packets to the request side device via at least any of the at least two or more of the wireless communication paths when the first request packet transmitted by the request side device is received for the first time. The at least two or more of the wireless communication paths establish connection or disconnection when the request side device receives the first response packet transmitted by the response side device for the first time.

In the control packet transmission system according to a third invention, which is in the first invention, the wireless communication path used for transmitting the first request packet received for the first time by the response side device and the wireless communication path used for transmitting the first response packet received for the first time by the request side device are wireless communications compliant with different communication standards.

In the control packet transmission system according to a fourth invention, which is in any of the first invention to the third invention, the request side device executes transmission of the first request packet to the response side device a plurality of times before the plurality of first response packets transmitted at the second packet communication step are received for the first time.

A control packet transmission method according to a fifth invention mutually transmits a control packet storing control information between a request side device that requests control and a response side device that responds to a control request from the request side device. The request side device and the response side device configure a client server system that performs wireless communication via a wireless communication path and uses MP-TCP. The control packet transmission method includes a computer executing: a first packet communication step of transmitting a plurality of first request packets indicative of a request to the response side device in the control packet to the response side device via at least one or more of the wireless communication paths; and a second packet communication step of transmitting a plurality of first response packets indicative of a response to the first request packet in the control packet to the request side device via at least one or more of the wireless communication paths when the response side device receives the first request packet transmitted at the first packet communication step for the first time.

A control packet transmission program according to a sixth invention mutually transmits a control packet storing control information between a request side device that requests control and a response side device that responds to a control request from the request side device. The request side device and the response side device configure a client server system that performs wireless communication via a wireless communication path and uses MP-TCP. The control packet transmission program includes a computer executing: a first packet communication step of transmitting a plurality of first request packets indicative of a request to the response side device in the control packet to the response side device via at least one or more of the wireless communication paths; and a second packet communication step of transmitting a plurality of first response packets indicative of a response to the first request packet in the control packet to the request side device via at least one or more of the wireless communication paths when the response side device receives the first request packet transmitted at the first packet communication step for the first time.

### Effects of the Invention

According to the first invention to the fourth invention, the control packet transmission system includes the request side device that transmits the plurality of first request packets to the response side device via at least one or more wireless communication paths, and the response side device that transmits the plurality of first response packets to the request side device via at least one or more wireless communication paths when the first request packet is received for the first time. In view of this, the request side device can more promptly receive the first response packet. This allows the client server system to achieve improvement in throughput while ensuring the reliability of communication.

Especially, according to the second invention, the request side device transmits the plurality of first request packets indicative of a request for connection or disconnection to the response side device via at least two or more wireless communication paths, the response side device transmits the plurality of first response packets to the request side device via at least any of the at least two or more wireless communication paths when the first request packet is received for the first time, and the at least two or more wireless communication paths establish connection or disconnection when the request side device receives the first response packet for the first time. In view of this, connections of the plurality of wireless communication paths can be established based on transmission and reception of the control packet transmitted via one wireless communication path. This allows the client server system to achieve further improvement in throughput while ensuring the reliability of communication.

Especially, according to the third invention, the wireless communication path used for transmitting the first request packet received for the first time by the response side device and the wireless communication path used for transmitting the first response packet received for the first time by the request side device are wireless communications compliant with different communication standards. In view of this, a temporarily effective wireless communication path can be selected during the period from the transmission of the first request packet by the request side device till the reception of the first response packet by the request side device. This allows the client server system with mobile communication to achieve improvement in throughput with more certainty while ensuring the reliability of communication.

Especially, according to the fourth invention, the request side device executes transmission of the first request packet a plurality of times before the request side device receives the first response packet for the first time. In view of this, the transmission of the first request packet by the request side device is less susceptible to an effect caused by fluctuations in communication quality between the wireless communication paths. This allows achieving improvement in accuracy of causing the request side device to more promptly receive the first response packet.

According to the fifth invention, the control packet transmission method includes the computer executing the first packet communication step of transmitting the plurality of first request packets to the response side device via at least one or more wireless communication paths, and the second packet communication step of transmitting the plurality of first response packets to the request side device via at least one or more wireless communication paths when the response side device receives the first request packet for the first time. In view of this, the request side device can more promptly receive the first response packet. This allows providing the client server system in which improvement in throughput is achieved while the reliability of communication is ensured.

According to the sixth invention, the control packet transmission program includes the computer executing the first packet communication step of transmitting the plurality of first request packets to the response side device via at least one or more wireless communication paths, and the second packet communication step of transmitting the plurality of first response packets to the request side device via at least one or more of the wireless communication paths when the response side device receives the first request packet for the first time. In view of this, the request side device can more promptly receive the first response packet. This allows providing the client server system in which improvement in throughput is achieved while the reliability of communication is ensured.

### BRIEF DESCRIPTION OF THE DRAWINGS

FIG. 1 is a schematic diagram illustrating an exemplary configuration of a control packet transmission system according to a first embodiment.

FIG. 2 is a schematic diagram illustrating exemplary configurations of respective devices configuring the control packet transmission system according to the first embodiment.

FIG. 3 is a schematic diagram illustrating exemplary detailed configurations of the respective devices configuring the control packet transmission system according to the first embodiment.

FIG. 4 is a schematic diagram illustrating an exemplary control packet transmitted by the control packet transmission system according to the first embodiment.

FIG. 5 is a flowchart illustrating an exemplary operation of the control packet transmission system according to the first embodiment.

FIG. 6 is a sequence diagram illustrating exemplary detailed operations of the respective devices configuring the control packet transmission system according to the first embodiment.

FIG. 7 is a sequence diagram illustrating a first modification of detailed operations of the respective devices configuring the control packet transmission system according to the first embodiment.

FIG. 8 is a sequence diagram illustrating a second modification of the detailed operations of the respective devices configuring the control packet transmission system according to the first embodiment.

FIG. 9 is a flowchart illustrating an exemplary operation of a control packet transmission system according to a second embodiment.

FIG. 10 is a sequence diagram illustrating exemplary detailed operations of respective devices configuring the control packet transmission system according to the second embodiment.

FIG. 11 is a sequence diagram illustrating a first modification of detailed operations of the respective devices configuring the control packet transmission system according to the second embodiment.

FIG. 12 is a sequence diagram illustrating a second modification of the detailed operations of the respective devices configuring the control packet transmission system according to the second embodiment.

FIG. 13 is a schematic diagram illustrating exemplary detailed configurations of respective devices configuring a control packet transmission system according to a third embodiment.

FIG. 14 is a sequence diagram illustrating exemplary detailed operations of the respective devices configuring the control packet transmission system according to the third embodiment.

FIG. 15 is a sequence diagram illustrating a modification of detailed operations of the respective devices configuring the control packet transmission system according to the third embodiment.

### DESCRIPTION OF PREFERRED EMBODIMENTS

The following describes an exemplary control packet transmission system, an exemplary control packet transmission method, and an exemplary control packet control program as embodiments of the present invention with reference to the drawings.

### First Embodiment: Control Packet Transmission System 100

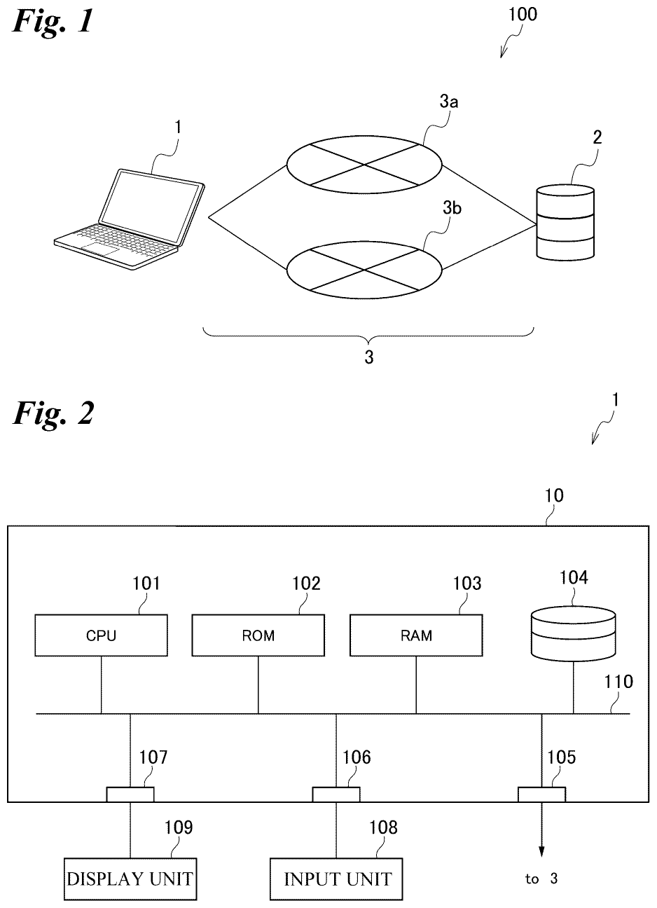

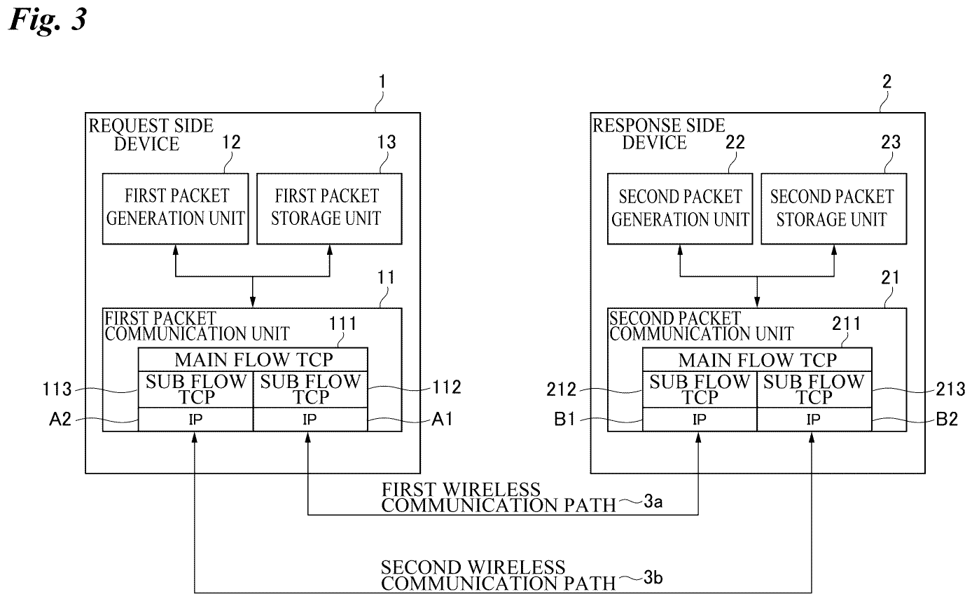

With reference to FIG. 1 to FIG. 3, an exemplary control packet transmission system 100 according to the embodiment will be described. FIG. 1 is a schematic diagram illustrating an exemplary configuration of the control packet transmission system 100 according to the embodiment. FIG. 2 is a schematic diagram illustrating exemplary configurations of respective devices 1, 2 configuring the control packet transmission system 100 according to the embodiment. FIG. 3 is a schematic diagram illustrating exemplary detailed configurations of the respective devices 1, 2 configuring the control packet transmission system 100 according to the embodiment.

### <Control Packet Transmission System 100>

The control packet transmission system 100 includes the request side device 1, the response side device 2, and a plurality of wireless communication paths 3 that communicably connects the request side device 1 and the response side device 2. The control packet transmission system 100 is a client server system that performs wireless communication using Multi Path-Transmission Control Protocol (MP-TCP). Here, a control packet means a packet including control information of each device configuring the client server system. The request side device 1 and the response side device 2 configuring the client server system mutually transmit the control packet via at least one or more wireless communication paths 3. Note that the client server system is configured of, for example, one or more clients and one server. Examples of connection configurations of the respective devices 1, 2 of the client server system include a bus type, a star type, and the like. Here, for simplification of the description, the case where one request side device 1 and one response side device 2 are used is described as an example, but the embodiment is not limited to this, and any of the devices 1, 2 may be configured of a plurality of devices.

### <Request Side Device 1>

The request side device 1 transmits the control packet to the response side device 2 via at least one or more wireless communication paths 3. The request side device 1 is, for example, a client device configuring the client server system, and transmits the generated control packet to a server configuring the system. For the request side device 1, for example, an electronic device, such as a laptop (notebook) PC or a desktop PC, is used.

The request side device 1 generates a plurality of control packets indicative of a request from the request side device 1 to the response side device 2, and transmits the plurality of control packets to the response side device 2 via at least one or more wireless communication paths 3.

The request side device 1 may be, for example, a server device configuring the client server system, and in this case, transmits the generated control packets to a client device configuring the system.

The request side device 1 includes a housing 10, a Central Processing Unit (CPU) 101, a Read Only Memory (ROM) 102, a Random Access Memory (RAM) 103, a storage unit 104, and I/Fs 105 to 107, for example, as illustrated in FIG. 2. The respective configurations 101 to 107 are connected via an internal bus 110.

Functions of the respective configurations of the request side device 1 are as follows. The CPU 101 controls the entire request side device 1. The ROM 102 stores operation codes of the CPU 101. The RAM 103 is a working area used when the CPU 101 operates. The storage unit 104 stores various kinds of information, such as database and learning target data. For the storage unit 104, for example, a data storage device, such as a Solid State Drive (SSD), is used besides a Hard Disk Drive (HDD). For example, the request side device 1 may have a Graphics Processing Unit (GPU) (not illustrated).

The I/F 105 is an interface for transmitting and receiving various kinds of information to and from the response side device 2 as necessary via the wireless communication path 3. The IF 106 is an interface for transmitting and receiving information to and from an input unit 108. For the input unit 108, for example, a keyboard is used, and an operator or the like of the request side device 1 inputs various kinds of information or a control command and the like of the request side device 1 via the input unit 108. The IF 107 is an interface for transmitting and receiving various kinds of information to and from a display unit 109. The display unit 109 displays various kinds of information saved in the storage unit 104. For the display unit 109, a display is used, and, for example, in the case of a touch panel type, it is provided integrally with the input unit 108.

The request side device 1 has a first packet communication unit 11, for example, as illustrated in FIG. 3. The request side device 1 may have, for example, a first packet generation unit 12 and a first packet storage unit 13. The respective configurations 11, 12, 13 are achieved by the CPU 101 executing programs stored in the storage unit 104 and the like using the RAM 103 as a working area. The request side device 1 may transmit the control packet generated by a device other than the request side device 1, or may transmit the control packet stored in a device other than the request side device 1. Note that, when the first packet communication unit 11 receives the control packet, it is considered that the request side device 1 receives the control packet.

### <First Packet Communication Unit 11>

The first packet communication unit 11 transmits the control packet to the response side device 2 via at least one or more wireless communication paths 3. The first packet communication unit 11 has, for example, a main flow TCP 111, and has a sub flow TCP 112 and a sub flow TCP 113 in the main flow TCP 111. The respective sub flow TCPs 112, 113 have set respective addresses A1, A2. Note that, when any of the respective sub flow TCPs 112, 113 receives the control packet, it is considered that the first packet communication unit 11 receives the control packet.

The sub flow TCP 112 is, for example, connected to a sub flow TCP 212 included in a second packet communication unit 21 of the response side device 2, which will be described below, via a first wireless communication path 3a. The first packet communication unit 11 transmits the control packet from the sub flow TCP 112 to the sub flow TCP 212 via the first wireless communication path 3a.

The sub flow TCP 113 is, for example, connected to a sub flow TCP 213 included in the second packet communication unit 21 of the response side device 2, which will be described below, via a second wireless communication path 3b. The first packet communication unit 11 transmits the control packet from the sub flow TCP 113 to the sub flow TCP 213 via the second wireless communication path 3b.

### <First Packet Generation Unit 12>

The first packet generation unit 12 generates, for example, a plurality of control packets indicative of a request from the request side device 1 to the response side device 2.

### <First Packet Storage Unit 13>

The first packet storage unit 13 stores, for example, the control packets generated by the first packet generation unit 12. The first packet storage unit 13 saves the various kinds of control packets obtained or generated by the respective configurations 11, 12 in the storage unit 104 as necessary.

### <Response Side Device 2>

The response side device 2 transmits the control packet to the request side device 1 via at least one or more wireless communication paths 3. The response side device 2 is, for example, a server device configuring the client server system, and transmits the generated control packet to a client configuring the system. For the response side device 2, for example, an electronic device, such as a laptop (notebook) PC or a desktop PC, is used.

The response side device 2 generates a plurality of control packets indicative of a response to the request from the request side device 1 to the response side device 2, and transmits the plurality of control packets to the request side device 1 via at least one or more wireless communication paths 3.

The response side device 2 may be, for example, a client device configuring the client server system, and in this case, transmits the generated control packets to a server configuring the system.

The response side device 2 has, for example, a similar configuration to that of the request side device 1 illustrated in FIG. 2, and includes a housing (not illustrated) corresponding to the housing 10, a CPU (not illustrated) corresponding to the CPU 101, a ROM (not illustrated) corresponding to the ROM 102, a RAM (not illustrated) corresponding to the RAM 103, a storage unit (not illustrated) corresponding to the storage unit 104, and one or more I/Fs (not illustrated) corresponding to the I/Fs 105 to 107. These respective configurations are connected via an internal bus (not illustrated) corresponding to the internal bus 110. These respective configurations of the response side device 2 have, for example, similar functions to those of the corresponding respective configurations of the request side device 1, and the descriptions are omitted.

The response side device 2 has, for example, as illustrated in FIG. 3, the second packet communication unit 21. The response side device 2 may have, for example, a second packet generation unit 22 and a second packet storage unit 23. The respective configurations 21, 22, 23 are achieved by the CPU in the response side device 2 executing programs stored in the storage unit and the like using the RAM as a working area. The response side device 2 may transmit the control packet generated by a device other than the response side device 2, or may transmit the control packet stored in a device other than the response side device 2. Note that, when the second packet communication unit 21 receives the control packet, it is considered that the response side device 2 receives the control packet.

### <Second Packet Communication Unit 21>

The second packet communication unit 21 transmits the control packet to the request side device 1 via at least one or more wireless communication paths 3. The second packet communication unit 21 has, for example, a main flow TCP 211, and has the sub flow TCP 212 and the sub flow TCP 213 in the main flow TCP 211. The respective sub flow TCPs 212, 213 have set respective addresses B1, B2. Note that, when any of the respective sub flow TCPs 212, 213 receives the control packet, it is considered that the second packet communication unit 21 receives the control packet.

The sub flow TCP 212 is, for example, connected to the sub flow TCP 112 included in the first packet communication unit 11 of the request side device 1 via the first wireless communication path 3a. The second packet communication unit 21 transmits the control packet from the sub flow TCP 212 to the sub flow TCP 112 via the first wireless communication path 3a.

The sub flow TCP 213 is, for example, connected to the sub flow TCP 113 included in the first packet communication unit 11 of the request side device 1 via the second wireless communication path 3b. The second packet communication unit 21 transmits the control packet from the sub flow TCP 213 to the sub flow TCP 113 via the second wireless communication path 3b.

### <Second Packet Generation Unit 22>

The second packet generation unit 22 generates, for example, a plurality of control packets indicative of a response to the request from the request side device 1 to the response side device 2.

### <Second Packet Storage Unit 23>

The second packet storage unit 23 stores, for example, the control packet generated by the second packet generation unit 22. The second packet storage unit 23 saves the various kinds of control packets obtained or generated by the respective configurations 21, 22 in a storage unit (not illustrated) configuring the response side device 2 as necessary.

### <Wireless Communication Path 3>

The wireless communication path 3 connects the request side device 1 and the response side device 2 in a wirelessly communicable manner. Since the present invention uses MP-TCP, the plurality of communicable wireless communication paths 3 are present in the control packet transmission system 100, and one or more wireless communication paths 3 are selected when wireless communication is performed.

Examples of the wireless communication paths 3 include wireless communications compliant with standards of 3G, 4G, 5G, Long Term Evolution (LTE), WiFi (registered trademark), Bluetooth (registered trademark), Wireless Gigabit (Wigig) (registered trademark), and the like.

Here, the plurality of wireless communication paths 3 means, for example, a combination of different wireless communication paths 3 among the above-described examples of the wireless communication paths 3. That is, the wireless communication path 3a and the wireless communication path 3b are wireless communications compliant with different standards, and, for example, are different in communication speed. The control packet transmission system 100 may conveniently select one or more wireless communication paths 3 corresponding to the communication speeds, communication qualities, and the like of the respective wireless communication paths 3a, 3b at the point when the control packet is transmitted.

### First Embodiment: Exemplary Operation of Control Packet Transmission System 100

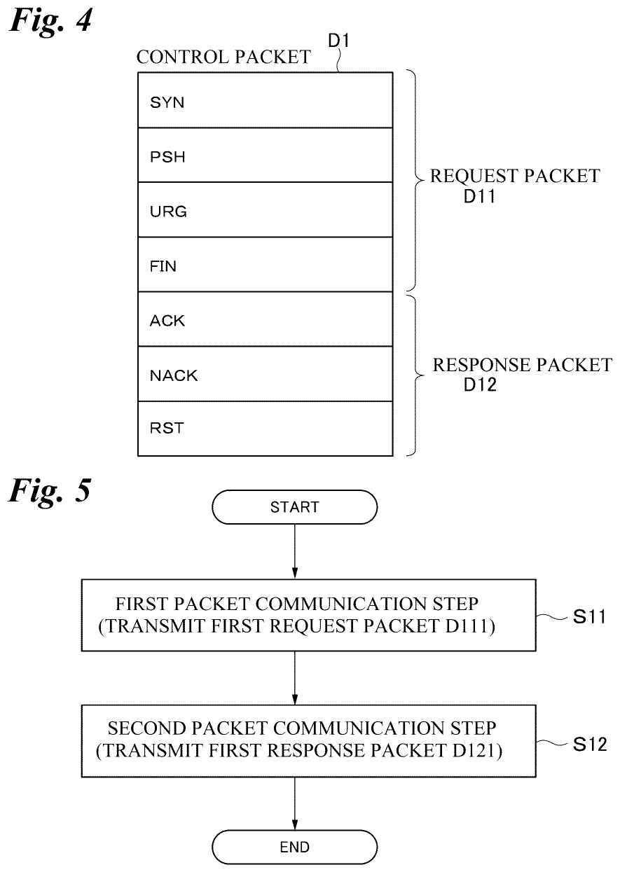

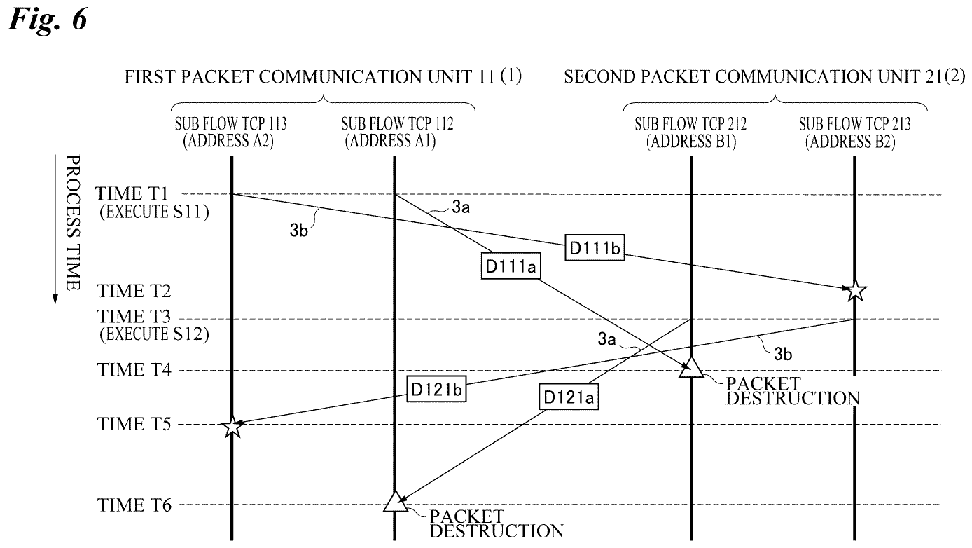

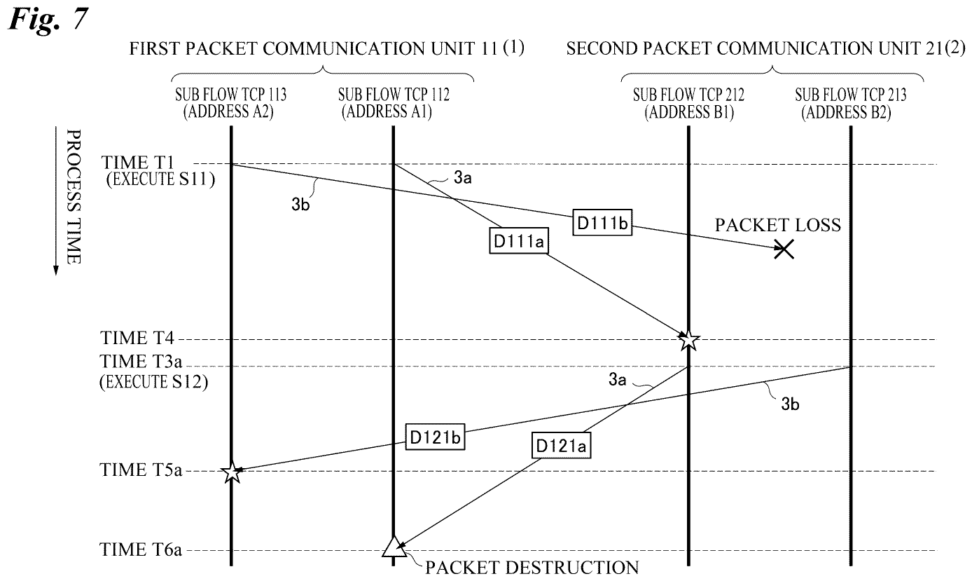

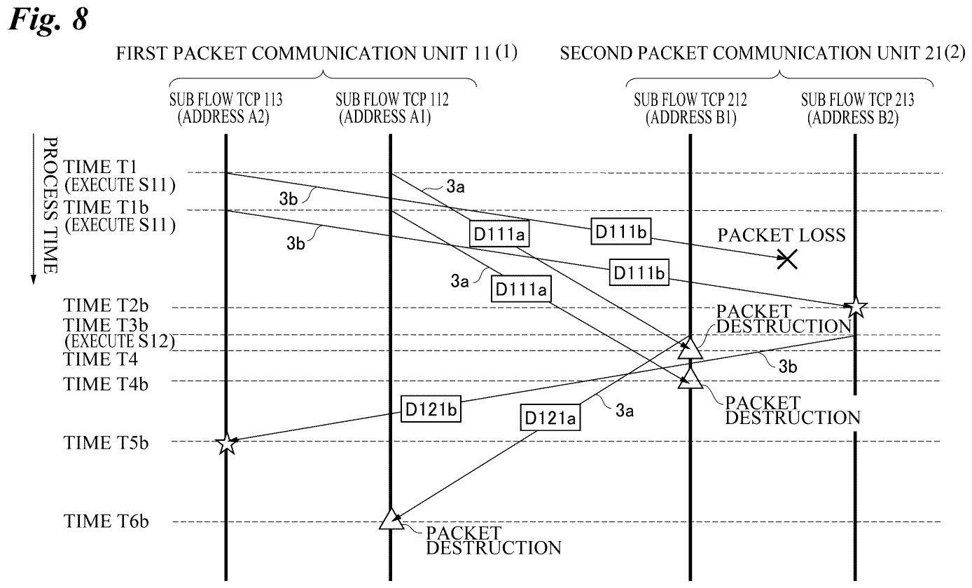

Next, with reference to FIG. 4 to FIG. 8, an exemplary operation of the control packet transmission system 100 according to the embodiment will be described. FIG. 4 is a schematic diagram illustrating an exemplary control packet transmitted by the control packet transmission system 100 according to the embodiment. FIG. 5 is a flowchart illustrating an exemplary operation of the control packet transmission system 100 according to the embodiment. FIG. 6 is a sequence diagram illustrating exemplary detailed operations of the respective devices 1, 2 configuring the control packet transmission system 100 according to the embodiment. FIG. 7 is a sequence diagram illustrating a first modification of detailed operations of the respective devices 1, 2 configuring the control packet transmission system 100 according to the embodiment. FIG. 8 is a sequence diagram illustrating a second modification of the detailed operations of the respective devices 1, 2 configuring the control packet transmission system 100 according to the embodiment.

The control packet transmission system 100 is executed via, for example, control packet transmission programs installed in the respective devices.

Here, a control packet D1 transmitted and received in the control packet transmission system 100 includes, for example, as illustrated in FIG. 4, a request packet D11 and a response packet D12.

### <Request Packet D11>

The request packet D11 is a control packet indicative of a request from the request side device 1 to the response side device 2 in the control packet D1. Examples of the request packet D11 include a SYN packet indicative of a request for communication connection to the response side device 2, a PSH packet indicative of a request to promptly hand over received data to an application layer to the response side device 2, an URG packet indicative of a request for urgent processing of data, a FIN packet indicative of a request for communication disconnection to the response side device 2, and the like.

Note that the request packet D11 may include a request from the response side device 2 to the request side device 1 similarly to the request from the request side device 1 to the response side device 2. Here, a description is made using the case where, in the request packet D11, the control packet indicative of the request from the request side device 1 to the response side device 2 is a first request packet D111 and the control packet indicative of the request from the response side device 2 to the request side device 1 is a second request packet D112 as an example.

Note that when the request packet D11 is the SYN packet, no connection is established between the respective devices 1 and 2 at the point when the request packet D11 is transmitted, and a connection is established between the respective devices 1 and 2 at the point when a positive response to the request packet D11 is made. When the request packet D11 is a control packet (for example, the PSH packet, the URG packet, the FIN packet, or the like described above) other than the SYN packet, a connection has already been established between the respective devices 1 and 2.

### <Response Packet D12>

The response packet D12 is a control packet indicative of a response to the request from the request side device 1 to the response side device 2 in the control packet D1. Examples of the response packet D12 include an ACK packet indicative of a positive response to the request to the response side device 2, a NACK packet indicative of a negative response to the request to the response side device 2, a RST packet indicative of a response of a unilateral disconnection to a connection request or a connection state to the response side device 2, and the like.

Note that the response packet D12 may include response content to the request from the response side device 2 to the request side device 1. In the present invention, in the response packet D12, the control packet indicative of the response to the request from the request side device 1 to the response side device 2 is a first response packet D121, and the control packet indicative of a response to the request from the response side device 2 to the request side device 1 is a second response packet D122.

The operation of the control packet transmission system 100 includes a first packet communication step S11 and a second packet communication step S12, for example, as illustrated in FIG. 5. Before the first packet communication step S1l, in the control packet transmission system 100, the first packet generation unit 12 generates a plurality of the first request packets D111 (D111a, D111b), or the first packet storage unit 13 stores the plurality of first request packets D111 generated outside the control packet transmission system 100.

### <First Packet Communication Step S11>

At Time T1, the first packet communication step S11 is executed. In the first packet communication step S11, for example, as illustrated in FIG. 6, the first packet communication unit 11 transmits at least two or more first request packets (D111a, D111b, . . . ) indicative of a request from the request side device 1 to the response side device 2 in the control packet D1 to the response side device 2 via at least two or more wireless communication paths 3 (3a, 3b . . . ). In this case, a risk caused by, for example, the packet communication speed of the wireless communication path 3 is reducible. This allows achieving further improvement in throughput. Here, for simplification of the description, the description is made with the number of the first request packets D111 being two and the number of the wireless communication paths 3 being two. Note that Time T indicates time passage in ascending order (T1, T2, T3, . . . ). For example, Time T and Times T3a, T3b, T3c indicate that respective similar processes are performed at different times, and the same applies to the other times. The same also applies to the following descriptions.

Here, the plurality of first request packets D111 (D111a, D111b, . . . ) may be simultaneously transmitted from, for example, the request side device 1, or providing time differences (for example, within approximately one second), the plurality of first request packets D111 (D111a, D111b, . . . ) may be sequentially transmitted in chronological order, and the same applies below. Here, while in the example in FIG. 6, the first request packet D111a is transmitted via the first wireless communication path 3a and the first request packet D111b is transmitted via the second wireless communication path 3b, the combinations of the respective wireless communication paths 3 (3a, 3b, . . . ) and the respective first request packets D111 (D111a, D111b, . . . ) may be freely interchanged.

### <Second Packet Communication Step S12>

At Time T3, the second packet communication step S12 is executed. In the second packet communication step S12, the second packet communication unit 21 transmits a plurality of the first response packets D121 indicative of response content to the first request packet D111 to the request side device 1 via at least one or more wireless communication paths 3 when the first request packet D111 transmitted from the first packet communication unit 11 is received for the first time.

Here, when the first request packet D111 is received for the first time indicates when the second packet communication unit 21 receives any of the first request packets D111 for the first time after the first packet communication unit 11 transmits any of the first request packets D111 irrespective of the order of transmission timings of the plurality of first request packets D111 (D111a, D111b, . . . ) transmitted from the first packet communication unit 11. In FIG. 6, after the respective first request packets D111a, D111b are transmitted from the first packet communication unit 11 at Time T1, the second packet communication unit 21 receives the first request packet D111b at Time T2, and thereafter, receives the first request packet D111a at Time T4. In this case, the first request packet iiib is the first request packet D111 received for the first time. Hereinafter, when received for the first time shall be regarded as similar to the above description.

When the second packet communication unit 21 receives the first request packet D111b, in the control packet transmission system 100, the second packet generation unit 22 generates the plurality of second request packets D121 (D121a, D121b), or the second packet storage unit 23 stores the plurality of second request packets D121 generated outside the control packet transmission system 100.

At Time T3, the second packet communication unit 21 transmits the plurality of first response packets D121a, D121b indicative of a response to the first request packet D111 to the first packet communication unit 11 via at least one or more wireless communication paths 3. In this case, the request side device 1 can more promptly receive the first response packet D121. This allows the client server system to achieve improvement in throughput while ensuring the reliability of communication.

At Time T4, after the first request packet D111b is received for the first time at Time T2, and when the overlapping first request packet D111a is further received, the second packet communication unit 21 does not transmit the first response packet D121a separately from the transmission of the first response packet D121a at Time T3 and destroys the overlapping first request packet D111a. In this case, the time required to generate and transmit the response packet D12 by the response side device 2 can be reduced. This allows achieving further improvement in throughput.

At Time T5, the sub flow TCP 113 receives the first response packet D121b. After Time T5, the sub flow TCP 112 receives the first response packet D121a at Time T6.

After the above-described respective steps are executed, the operation of the control packet transmission system 100 according to the embodiment is terminated. Note that the control packet transmission system 100 may repeatedly execute, for example, the above-described respective steps.

Note that, when the first request packet D111 according to the embodiment is the SYN packet, the control packet transmission system 100 can establish unidirectional connections of the plurality of wireless communication paths 3 (3a, 3b, . . . ) based on the transmission and reception of the control packet D1 transmitted via one wireless communication path 3. For example, even in the case where the first request packet DIII and the first response packet D121 are mutually transmitted via the wireless communication path 3b connecting the sub flow TCP 113 and the sub flow TCP 213, a unidirectional connection of the wireless communication path 3a can be established in addition to the wireless communication path 3b by including information (for example, the addresses A1, B1) of the sub flow TCP 112 and the sub flow TCP 212 in the respective packets D111, D121. This allows the client server system to achieve further improvement in throughput while ensuring the reliability of communication. In this case, the unidirectional connections of the plurality of wireless communication paths 3 (3a, 3b) used for transmitting the control packet D1 can be established in any case of the case where both the control packets D1 of the first request packet D111 and the first response packet D121 are simultaneously transmitted via the plurality of wireless communication paths 3 (both 3a and 3b), the case where only any one of the control packets D1 of the first request packet D111 and the first response packet D121 is transmitted via one wireless communication path 3 (any of 3a and 3b), and the case where both the control packets D1 of the first request packet D111 and the first response packet D121 are transmitted via one wireless communication path 3 (each of 3a and 3b is selected once).

For example, as shown in Table 1, a plurality of cases of the communication speeds of the first wireless communication path 3a and the second wireless communication path 3b are assumed. The time required to complete a data communication preparation indicates the time from the start of the first packet communication step S11 till the completion of the second packet communication step S12. UL indicates the time required from the transmission of the control packet D1 from the first packet communication unit 11 till the reception of the control packet D1 by the second packet communication unit 12, and DL indicates the time required from the transmission of the control packet D1 from the second packet communication unit 12 till the reception of the control packet D1 by the first packet communication unit 11.

TABLE 1

| | First wireless | | Second wireless | | Time required to complete data | | |
|---|---|---|---|---|---|---|---|
| | communication path 3a | | communication path 3b | | communication preparation | | |
| | UL | DL | UL | DL | Conventional | Present | Reduction |
| Name | [ms] | [ms] | [ms] | [ms] | method [ms] | invention [ms] | rate |
| Case 1 | 60 | 100 | 20 | 20 | 160 | 40 | ¼ |
| Case 2 | 100 | 20 | 20 | 20 | 120 | 40 | ⅓ |
| Case 3 | 100 | 100 | 20 | 20 | 200 | 40 | ⅕ |
| Case 4 | 10 | 20 | 20 | 10 | 30 | 20 | ⅔ |
| Case 5 | 10 | 10 | 20 | 20 | 20 | 20 | 1 |

As shown in Cases 1 to 3, when the second communication path 3b has a fast communication speed compared with the communication speed of the first communication path 3a, the time required to complete the data communication preparation according to the present invention is substantially reducible compared with the conventional method. As shown in Case 4, even when the first wireless communication path 3a is faster for UL and the second wireless communication path 3b is faster for DL, the present invention allows communication via the respective faster wireless communication paths 3, and therefore, the time required to complete the data communication preparation is reducible compared with the conventional method.

Note that, when the first wireless communication path 3a is faster than the second wireless communication path 3b as shown in Case 5, the present invention can complete the data communication preparation in a time period similar to that in the conventional method.

### First Embodiment: Modification of Operation of Control Packet Transmission System 100

### <First Packet Communication Step S11>

For example, as illustrated in FIG. 7, the first request packet D111b transmitted from the first packet communication unit 11 via the second communication path 3b may be lost in some cases before it reaches the sub flow TCP 213 from the sub flow TCP 113. In this case, the first request packet D111a is the first request packet D111 received for the first time. The first request packet D111a is received later than the first request packet D111b by a difference between Time T4 and Time T2, and therefore, Time T3a at which the second packet communication unit 21 transmits the plurality of first response packets D121a, D121b to the first packet communication unit 11 is later than Time T3 by the difference between Time T4 and Time T2.

Here, for example, as illustrated in FIG. 8, after the first packet communication step S11 is executed at Time T1, executing the first packet communication step S11 again at Time Tib may bring the time at which the second packet communication unit 21 receives the first request packet D111 for the first time forward in some cases. That is, while the first request packet D111a is originally supposed to be received delaying by the difference between Time T4 and Time T2 compared with the first request packet D111b, the delay can be limited to a difference between Time T1 and Time Tib. Specifically, when the communication speed of the first communication path 3a is half of the communication speed of the second communication path 3b and the first packet communication step S11 is executed three times at constant intervals between Times T1 and T2, the difference between Time T4 and Time T2 is 1×(T2−T1), the difference between Time T1 and Time Tib is ⅓×(T2−T1), and as the result, the delay period can be limited to ⅓. Note that, when the communication speed of the first communication path 3a is ¾ of the communication speed of the second communication path 3b, the difference between Time T4 and Time T2 is ¼×(T2−T1), the difference between Time T1 and Time Tib is ⅓×(T2−T1), and as the result, the delay period can be limited to ¼.

In this case, the transmission of the first request packet D11 by the first packet communication unit 11 is less susceptible to an effect caused by fluctuations in communication quality between the wireless communication paths 3 (for example, between the respective wireless communication paths 3a and 3b). This allows achieving improvement in accuracy of causing the request side device 1 to more promptly receive the first response packet D121.

The example of executing the first packet communication step S11 a plurality of times has been described above. Meanwhile, it is possible to consider that the first packet communication unit 11 sequentially transmits at least two or more first request packets D111 (D111a, D111b, . . . ) in chronological order via one wireless communication path 3 (for example, any of the respective wireless communication paths 3a, 3b) at one first packet communication step S11. In this case, the transmission of the first request packet D11 by the first packet communication unit 11 is less susceptible to an effect caused by temporal fluctuations in communication quality of the wireless communication path 3. This allows achieving improvement in accuracy of causing the request side device 1 to more promptly receive the first response packet D11. Here, examples of the temporal fluctuations in communication quality of the wireless communication path 3 may include fading and the like caused when, for example, the wireless communication of the control packet transmission system 100 is mobile communication.

According to the embodiment, the control packet transmission system 100 includes the request side device 1 that transmits the plurality of first request packets D111 to the response side device 2 via at least one or more wireless communication paths 3, and the response side device 2 that transmits the plurality of first response packets D121 to the request side device 1 via at least one or more wireless communication paths 3 when the first request packet D111 is received for the first time. In view of this, the request side device 1 can more promptly receive the first response packet D121. This allows the client server system to achieve improvement in throughput while ensuring the reliability of communication.

According to the embodiment, the request side device 1 transmits the plurality of first request packets D111 indicative of a request for connection or disconnection to the response side device 2 via at least two or more wireless communication paths 3, the response side device 2 transmits the plurality of first response packets D121 to the request side device 1 via at least any of the at least two or more wireless communication paths 3 when the first request packet D111 is received for the first time, and the at least two or more wireless communication paths 3 establish connection or disconnection when the request side device 1 receives the first response packet D121 for the first time. In view of this, the connections of the plurality of wireless communication paths 3 can be established based on the transmission and reception of the control packet D1 transmitted via one wireless communication path 3. This allows the client server system to achieve further improvement in throughput while ensuring the reliability of communication.

According to the embodiment, the request side device 1 transmits the first request packet D111 a plurality of times before the first response packet D121 is received for the first time. In view of this, the transmission of the first request packet D111 by the request side device 1 is less susceptible to an effect caused by fluctuations in communication quality between the wireless communication paths 3. This allows achieving improvement in accuracy of causing the request side device 1 to more promptly receive the first response packet D121.

According to the embodiment, the control packet transmission method includes a computer executing the first packet communication step S11 of transmitting the plurality of first request packets D111 to the response side device 2 via at least one or more wireless communication paths 3, and the second packet communication step S12 of transmitting the plurality of first response packets D121 to the request side device 1 via at least one or more wireless communication paths 3 when the response side device 2 receives the first request packet D111 for the first time. In view of this, the request side device 1 can more promptly receive the first response packet D121. This allows providing the client server system in which improvement in throughput is achieved while the reliability of communication is ensured.

According to the embodiment, the control packet transmission program includes the computer executing the first packet communication step S11 of transmitting the plurality of first request packets D111 to the response side device 2 via at least one or more wireless communication paths 3, and the second packet communication step S12 of transmitting the plurality of first response packets D121 to the request side device 1 via at least one or more wireless communication paths 3 when the response side device 2 receives the first request packet D111 for the first time. In view of this, the request side device 1 can more promptly receive the first response packet D121. This allows providing the client server system in which improvement in throughput is achieved while the reliability of communication is ensured.

### Second Embodiment: Exemplary Operation of Control Packet Transmission System 100

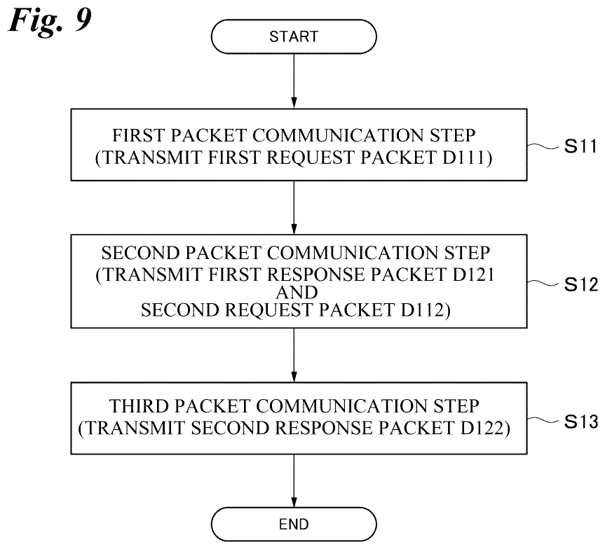

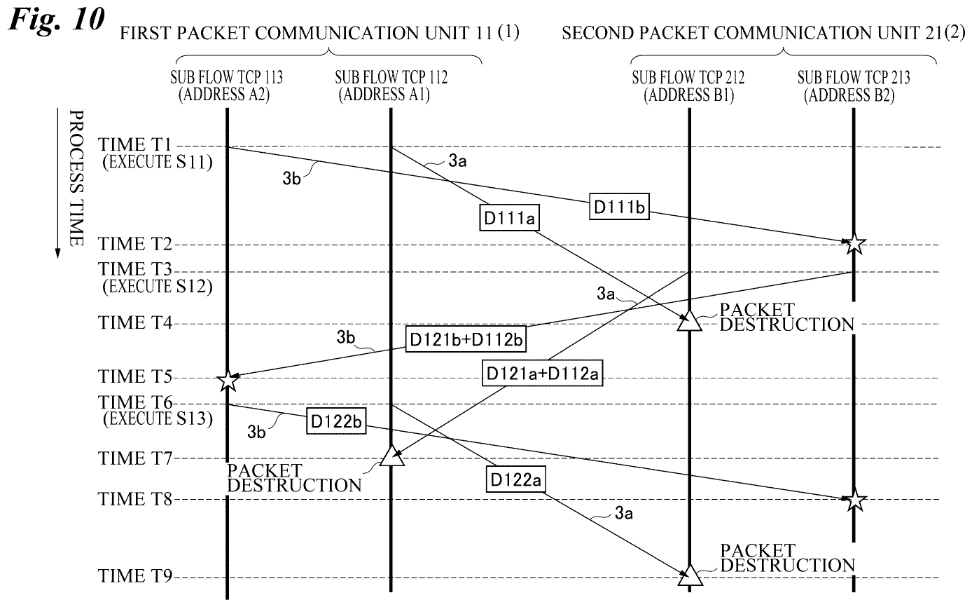

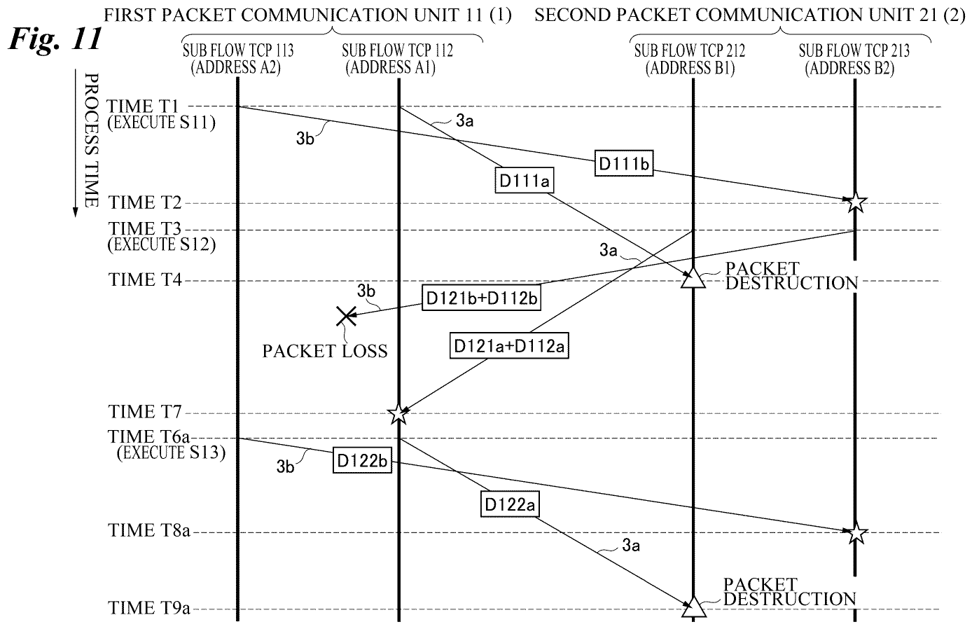

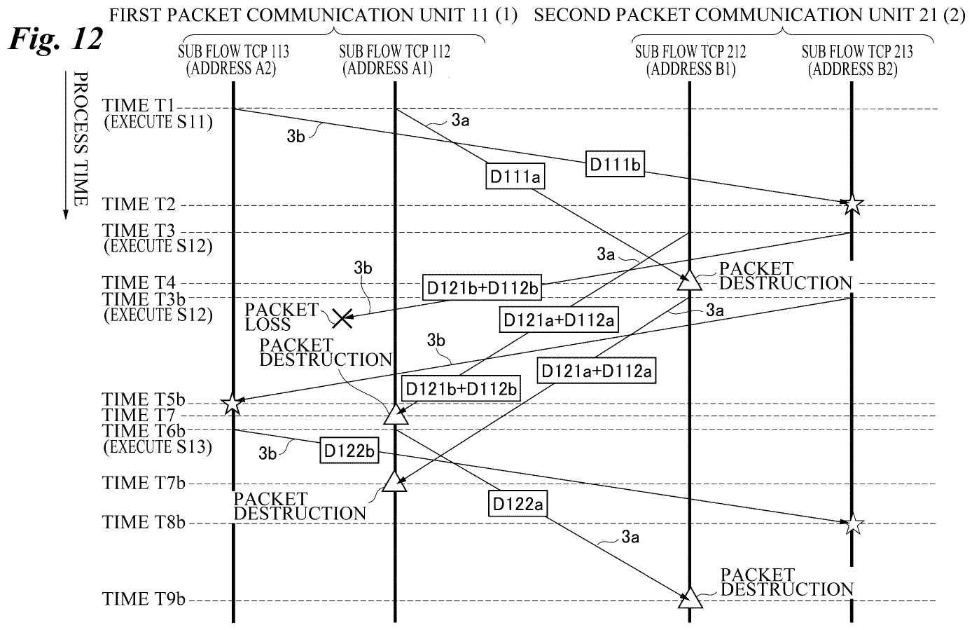

Next, with reference to FIG. 9 to FIG. 12, an exemplary operation of the control packet transmission system 100 according to the embodiment will be described. FIG. 9 is a flowchart illustrating the exemplary operation of the control packet transmission system 100 according to the embodiment. FIG. 10 is a sequence diagram illustrating exemplary detailed operations of the respective devices 1, 2 configuring the control packet transmission system 100 according to the embodiment. FIG. 11 is a sequence diagram illustrating a first modification of detailed operations of the respective devices 1, 2 configuring the control packet transmission system 100 according to the embodiment. FIG. 12 is a sequence diagram illustrating a second modification of the detailed operations of the respective devices 1, 2 configuring the control packet transmission system 100 according to the embodiment. The embodiment differs from the first embodiment in that the operation of the control packet transmission system 100 includes a third packet communication step 3. Note that descriptions of similar configurations to the above-described contents are omitted.

The operation of the control packet transmission system 100 further includes a third packet communication step S13 after the second packet communication step, for example, as illustrated in FIG. 9.

### <First Packet Communication Step S11>

At Time T1, the first packet communication step S11 is executed. In the first packet communication step S11, the first packet communication unit 11 transmits at least two or more first request packets (D111a, D111b, . . . ), indicative of a request for connection or disconnection from the request side device 1 to the response side device 2 in the control packet D1 to the response side device 2 via at least two or more wireless communication paths 3 (3a, 3b . . . ) at Time T1, for example, as illustrated in FIG. 10.

### <Second Packet Communication Step S12>

At Time T3, the second packet communication step S12 is executed. In the second packet communication step S12, the second packet communication unit 21 transmits the plurality of second request packets D112 indicative of a request for connection or disconnection to the request side device 1 in the control packet D1 to the request side device 1 together with the first response packet D121 via at least one or more wireless communication paths 3 when the first request packet D111 transmitted from the first packet communication unit 11 is received for the first time.

At Time T7, after the request side device 1 receives a second request packet D112b for the first time at Time T5, and when the request side device 1 further receives an overlapping second request packet D112a, the first packet communication unit 11 does not transmit the first response packet D122a separately from the transmission of the second response packet D122a at Time T6 and destroys the overlapping second request packet D112a. In view of this, the time required to generate and transmit the response packet D12 by the request side device 1 is reducible. This allows achieving further improvement in throughput.

### <Third Packet Communication Step S13>

At Time T6, the third packet communication step S13 is executed. In the third packet communication step S13, the first packet communication unit 21 transmits the plurality of second response packets D122 indicative of a response to the second request packet D112 received for the first time to the response side device 2 via at least one or more wireless communication paths 3 when the second request packet D112 is received for the first time. In this case, connection or disconnection of the connection between the request side device 1 and the response side device 2 can be more promptly established. This allows achieving further improvement in throughput.

At Time T6, the first packet communication unit 21 transmits the plurality of second response packets D122a, D122b to the response side device 2 via, for example, the plurality of wireless communication paths 3a, 3b.

At Time T7, the sub flow TCP 112 receives the first response packet D121 and the second request packet D112. At Time T8, the sub flow TCP 213 receives the first response packet D121b. After Time T8, at Time T9, the sub flow TCP 212 receives the second response packet D122a.

Note that, when the first request packet D111 and the second request packet D112 according to the embodiment are the SYN packets, the control packet transmission system 100 can establish bidirectional connections of the plurality of wireless communication paths 3 (3a, 3b, . . . ) based on the transmission and reception of the control packet D1 transmitted via one wireless communication path 3. For example, in addition to the example of the first request packet D111 and the first response packet D121 described above, also in the case where the second request packet D112 and the second response packet D122 are mutually transmitted via the wireless communication path 3b connecting the sub flow TCP 113 and the sub flow TCP 213, a bidirectional connection of the wireless communication path 3a can be established in addition to the wireless communication path 3b by including the information (for example, the addresses A1, B1) of the sub flow TCP 112 and the sub flow TCP 212 in the respective packets D111, D121. This allows the client server system to achieve further improvement in throughput while ensuring the reliability of communication. In this case, the bidirectional connections of the plurality of wireless communication paths 3 (3a, 3b) used for transmitting the control packet D1 can be established in any case of the case where all the control packets D1 of the first request packet D111, the second request packet D112, and the second response packet D122 are simultaneously transmitted via the plurality of wireless communication paths 3 (both 3a and 3b), the case where only any one of the control packets D1 of the first request packet D111, the second request packet D112, and the second response packet D122 is transmitted via the plurality of wireless communication paths 3 (both 3a and 3b), the case where only any one of the control packets D1 of the first request packet D111, the second request packet D112, and the second response packet D122 is transmitted via one wireless communication path 3 (any of 3a and 3b), and the case where all the control packets D1 of the first request packet D111, the second request packet D112, and the second response packet D122 are transmitted via one wireless communication path 3 (each of 3a, 3b is selected at least once or more).

### Second Embodiment: Modification of Operation of Control Packet Transmission System 100

### <First Packet Communication Step S11>

For example, as illustrated in FIG. 11, the first response packet D121b and the second request packet D112b transmitted from the second packet communication unit 12 via the second communication path 3b may be lost in some cases before reaching the sub flow TCP 113 from the sub flow TCP 213. In this case, the first response packet D121a and the second request packet D112a are the first response packet D121 and the second request packet D111 received for the first time. The second request packet D112a is received later than the second request packet D112b by a difference between Time T7 and Time T5, and therefore, Time T6a at which the first packet communication unit 11 transmits the plurality of second response packets D122a, D122b to the second packet communication unit 21 is later than Time T6 by the difference between Time T7 and Time T5.

Here, for example, as illustrated in FIG. 12, after the second packet communication step S12 is executed at Time T3, executing the second packet communication step S12 again at Time T3b may bring the time at which the first packet communication unit 11 receives the second request packet D112 for the first time forward in some cases. That is, while the second request packet D112a is originally supposed to be received delaying by the difference between Time T7 and Time T5 compared with the second request packet D112b, the delay can be limited to a difference between Time T6 and Time T6b. Specifically, when the communication speed of the first communication path 3a is half of the communication speed of the second communication path 3b and the first packet communication step S11 is executed three times at constant intervals between Times T3 and T7, the difference between Time T7 and Time T5 is 1×(T7−T3), the difference between Time T6 and Time T6b is ⅓×(T7−T3), and as the result, the delay period can be limited to ⅓. Note that, when the communication speed of the first communication path 3a is ¾ of the communication speed of the second communication path 3b, the difference between Time T7 and Time T5 is ¼×(T7−T3), the difference between Time T1 and Time Tib is ⅓×(T7−T3), and as the result, the delay period can be limited to ¼.

In this case, the transmission of the second request packet D12 by the second packet communication unit 21 is less susceptible to an effect caused by fluctuations in communication quality of the wireless communication path 3. This allows achieving improvement in accuracy of causing the response side device 2 to more promptly receive the second response packet D122.

According to the embodiment, the request side device 1 transmits the plurality of first request packets D111 indicative of a request for connection or disconnection to the response side device 2 via at least two or more wireless communication paths 3, the response side device 2 transmits the plurality of first response packets D121 and the plurality of second request packets D112 indicative of a request for connection or disconnection to the request side device 1 to the request side device 1 together with the plurality of first response packets D121 via at least any of the at least two or more wireless communication paths 3 when the first request packet D111 indicative of a request for connection or disconnection to the response side device 2 is received for the first time, the request side device 1 transmits the plurality of second response packets D122 indicative of a response to the second request packet D112 received for the first time to the response side device 2 via at least any of the at least two or more wireless communication paths 3 when the second request packet D112 is received for the first time, and the at least two or more wireless communication paths 3 establish connection or disconnection when the response side device 2 receives the second response packet D112 for the first time. In view of this, the connections of the plurality of wireless communication paths 3 can be established based on the transmission and reception of the control packet D1 transmitted via one wireless communication path 3. This allows the client server system to achieve further improvement in throughput while ensuring the reliability of communication.

### Third Embodiment: Exemplary Control Packet Transmission System 100

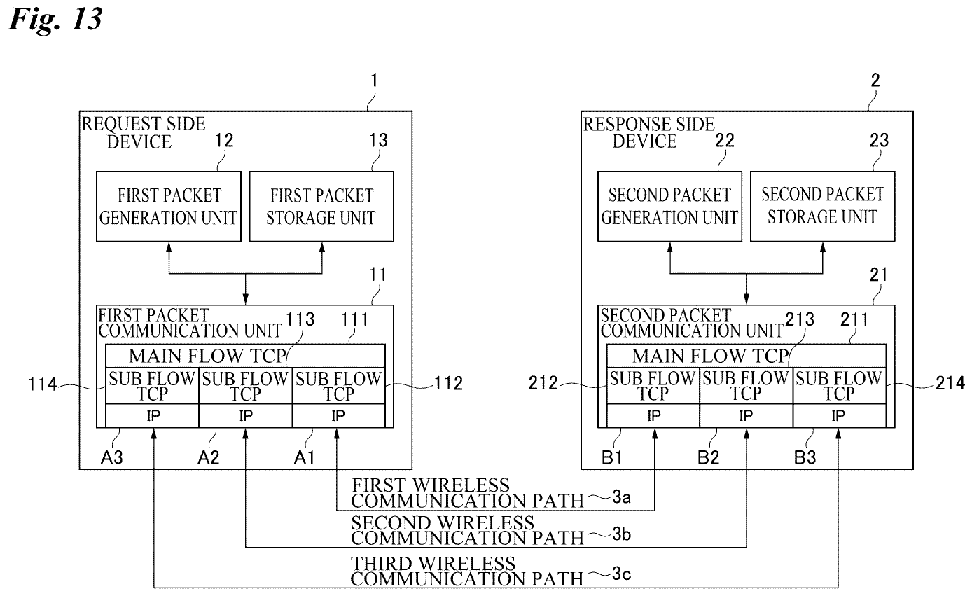

Next, with reference to FIG. 13, an exemplary control packet transmission system 100 according to the embodiment will be described. FIG. 13 is a schematic diagram illustrating exemplary detailed configurations of the respective devices 1, 2 configuring the control packet transmission system 100 according to the embodiment. The embodiment differs from the first embodiment in that the first packet communication unit 11 and the second packet communication unit 21 in the control packet transmission system 100 further communicate in a wireless manner via a third wireless communication path 3c. Note that descriptions of similar configurations to the above-described contents are omitted.

### <First Packet Communication Unit 11>

The first packet communication unit 11 has, for example, as illustrated in FIG. 13, the sub flow TCP 112, the sub flow TCP 113, and a sub flow TCP 114 in the main flow TCP 110. The respective sub flow TCPs 112, 113, 114 have set respective addresses A1, A2, A3. Note that, when any of the respective sub flow TCPs 112, 113, 114 receives the control packet, it is considered that the first packet communication unit 11 receives the control packet.

The sub flow TCP 114 is, for example, connected to a sub flow TCP 214 included in the second packet communication unit 21 of the response side device 2, which will be described below, via the third wireless communication path 3c. The first packet communication unit 11 transmits the control packet to the sub flow TCP 214 from the sub flow TCP 114 via the third wireless communication path 3c.

### <Second Packet Communication Unit 21>

The second packet communication unit 21 has, for example, the sub flow TCP 212, the sub flow TCP 213, and the sub flow TCP 214 in the main flow TCP 211. The respective sub flow TCPs 212, 213, 214 have set respective addresses B1, B2, B3. Note that, when any of the respective sub flow TCPs 212, 213, 214 receives the control packet, it is considered that the second packet communication unit 21 receives the control packet.

The sub flow TCP 214 is, for example, connected to the sub flow TCP 114 included in the first packet communication unit 111 of the request side device 1 via the third wireless communication path 3c. The second packet communication unit 21 transmits the control packet to the sub flow TCP 114 from the sub flow TCP 214 via the second wireless communication path 3c.

### Third Embodiment: Exemplary Operation of Control Packet Transmission System 100

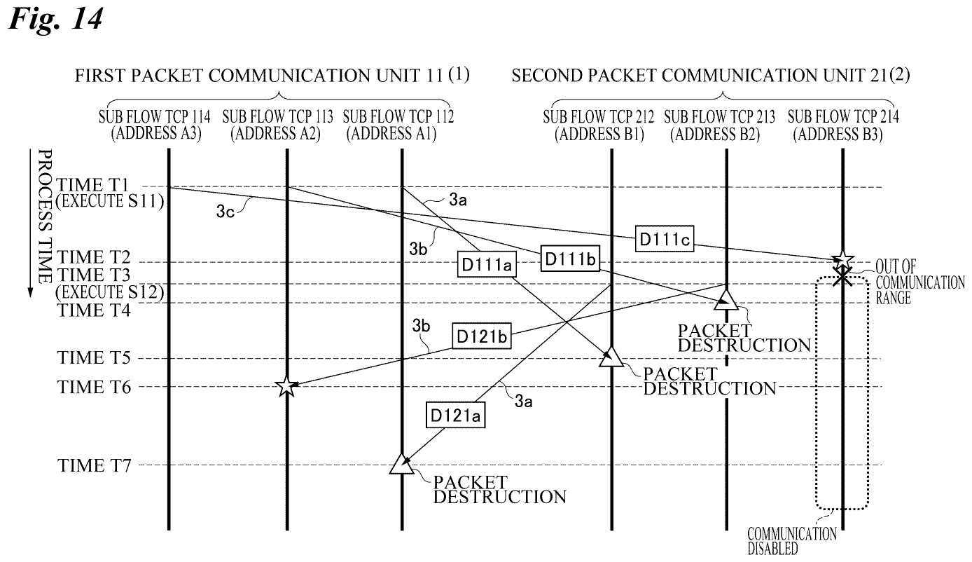

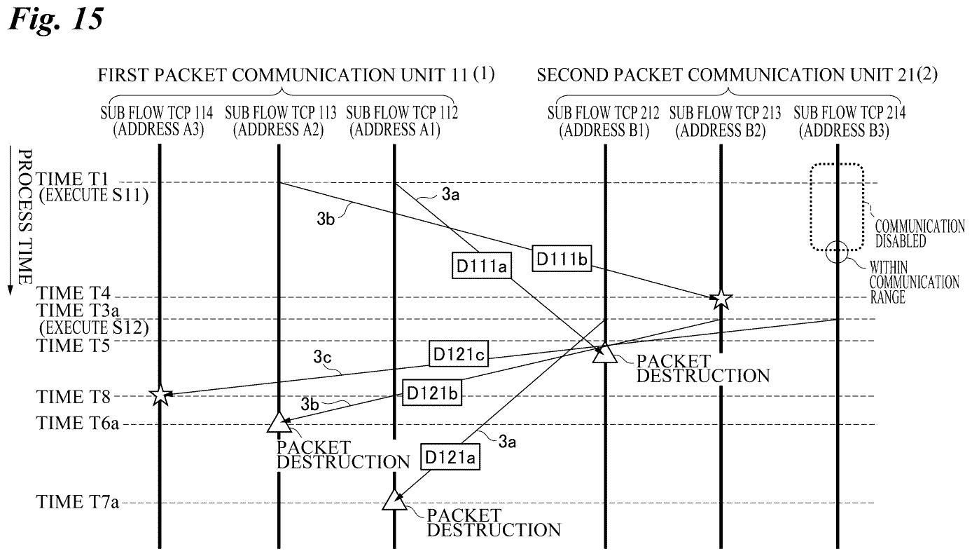

Next, with reference to FIG. 14 to FIG. 15, an exemplary operation of the control packet transmission system 100 according to the embodiment will be described. FIG. 14 is a sequence diagram illustrating exemplary detailed operations of the respective devices 1, 2 configuring the control packet transmission system 100 according to the embodiment. FIG. 15 is a sequence diagram illustrating a modification of detailed operations of the respective devices 1, 2 configuring the control packet transmission system 100 according to the embodiment.

Before the first packet communication step S11, in the control packet transmission system 100, the first packet generation unit 12 generates the plurality of first request packets D111 (D111a, D111b, D111c), or the first packet storage unit 13 stores the plurality of first request packets D111 generated outside the control packet transmission system 100.

### <First Packet Communication Step S11>

At Time T1, the first packet communication step S11 is executed. In the first packet communication step S11, the first packet communication unit 11 transmits, for example, as illustrated in FIG. 14, at least three or more first request packets (D111a, D111b, D111c . . . ), indicative of a request from the request side device 1 to the response side device 2 in the control packet D1 to the response side device 2 via at least three or more wireless communication paths 3 (3a, 3b, 3c . . . ).

At Time T2, the second packet communication unit 21 receives the first request packet D111c first among the first request packets D111 transmitted from the first packet communication unit 11. At this time, the control packet transmission system 100 transitions from the first packet communication step S11 to the second packet communication step S12.

### <Second Packet Communication Step S12>

At Time T3, the second packet communication step S12 is executed. Here, before Time T3, the third wireless communication path 3c goes out of the communication range, and thus, the wireless communication via the third wireless communication path 3c is disabled. In the second packet communication step S12, the second packet communication unit 21 transmits the plurality of first response packets D121 (D111a, D111b . . . ) indicative of a response to the first request packet D111 to the request side device 1 via at least two or more wireless communication paths 3 (3a, 3b . . . ) excluding the third wireless communication path 3c.

Thereafter, the second packet communication unit 21 receives the first request packet D111b at Time T4, and receives the first request packet D111a at Time T5. In this case, it can be said that the time until the execution of the second packet communication step S12 can be reduced by the difference between Time T4 and Time T2 by communicating via the third wireless communication path 3c.

Thus, the third wireless communication path 3c is a standard for short distance high speed communication, and is compliant with a different communication standard from those of, for example, the first wireless communication path 3a and the second wireless communication path 3b, and therefore, when mobile communication with at least any of the respective devices 1, 2 moving in and out of the communication range of the third wireless communication path 3c is performed, the first control packet communication step S11 is completed via the third wireless communication path 3c, and thus, the response from the second packet communication unit 21 to the first packet communication unit 11 can be completed even when the wireless communication via the third wireless communication path 3c is disabled before the second control packet communication step S12 is completed. In this case, a part of the mobile communication of the control packet transmission system 100 can be executed via the third wireless communication path 3c, which is a communication standard effective in a short distance. This allows the client server system that performs mobile communication to achieve improvement in throughput with more certainty while ensuring the reliability of communication.

By a similar operation, a part of the wireless communication of the control packet transmission system 100 can be executed via the third wireless communication path 3c in an environment with unstable communication quality or a situation with temporary communication quality. This allows the client server system to achieve improvement in throughput with more certainty while ensuring the reliability of communication.

### Third Embodiment: Modification of Operation of Control Packet Transmission System 100

### <First Packet Communication Step S11>

At Time T4, the second packet communication unit 21 receives the first request packet D111b first among the first request packets D111 transmitted from the first packet communication unit 11. At this time, the control packet transmission system 100 transitions from the first packet communication step S11 to the second packet communication step S12.

### <Second Packet Communication Step S12>

At Time T3a, the second packet communication step S12 is executed. Here, before Time T3a, the third wireless communication path 3c goes from out of the communication range to within the communication range, and the wireless communication via the third wireless communication path 3c is enabled. In the second packet communication step S12, the second packet communication unit 21 transmits the plurality of first response packets D121 (D111a, D111b, D111c . . . ) indicative of a response to the first request packet D111 to the request side device 1 via at least three or more wireless communication paths 3 (3a, 3b, 3c . . . ) including the third wireless communication path 3c.

Thereafter, the first packet communication unit 11 receives the first response packet D121c for the first time at Time T8. Thereafter, the first packet communication unit 11 receives the first response packet D121b at Time T6a. In this case, it can be said that the time until the completion of the second packet communication step S12 can be reduced by a difference between Time T6a and Time T8 by communicating via the third wireless communication path 3c.

Thus, the third wireless communication path 3c is a standard for short distance high speed communication, and is compliant with a different communication standard from those of, for example, the first wireless communication path 3a and the second wireless communication path 3b, and therefore, when mobile communication with at least any of the respective devices 1, 2 moving in and out of the communication range of the third wireless communication path 3c is performed, the wireless communication via the third wireless communication path 3c is enabled after the completion of the first control packet communication step S11, and thus, the response from the second packet communication unit 21 to the first packet communication unit 11 can be completed even when the wireless communication via the third wireless communication path 3c is additionally executed from the second control packet communication step S12. In this case, a part of the mobile communication of the control packet transmission system 100 can be executed via the third wireless communication path 3c, which is a communication standard effective in a short distance. This allows the client server system that performs mobile communication to achieve improvement in throughput with more certainty while ensuring the reliability of communication.

By a similar operation, a part of the wireless communication of the control packet transmission system 100 can be executed via the third wireless communication path 3c in an environment with unstable communication quality or a situation with temporary communication quality. This allows the client server system to achieve improvement in throughput with more certainty while ensuring the reliability of communication.

According to the embodiment, the wireless communication path 3 used for transmitting the first request packet D111 received for the first time by the response side device 2 and the wireless communication path 3 used for transmitting the first response packet D121 received for the first time by the request side device 1 are wireless communications compliant with different communication standards. In view of this, the wireless communication path 3 that is temporarily effective can be selected in a time period from the transmission of the first request packet D111 by the request side device 1 till the reception of the response packet D121 by the request side device 1. This allows, for example, the client server system that performs mobile communication to achieve improvement in throughput with more certainty while ensuring the reliability of communication.

While the embodiments of the present invention have been described, these embodiments have been presented by way of example, and are not intended to limit the scope of the invention. The novel embodiments described herein can be embodied in a variety of other configurations. Various omissions, substitutions, and changes can be made without departing from the gist of the invention. The embodiments and the modifications thereof are within the scope and the gist of the invention and within the scope of the inventions described in the claims and their equivalents.

### DESCRIPTION OF REFERENCE SIGNS

100: Control packet transmission system
1: Request side device
10: Housing
101: CPU
102: ROM
103: RAM
104: Storage unit
105: I/F
106: I/F
107: I/F
108: Input unit
109: Display unit
110: Internal bus
11: First packet communication unit
111: Main flow TCP
112: Sub flow TCP
113: Sub flow TCP
114: Sub flow TCP
12: First packet generation unit
13: First packet storage unit
2: Response side device
21: Second packet communication unit
121: Main flow TCP
122: Sub flow TCP
123: Sub flow TCP
124: Sub flow TCP
22: Second packet generation unit
23: Second packet storage unit
3: Wireless communication path
A, B: Address
D1: Control packet
D11: Request packet
D111: First request packet
D112: Second request packet
D12: Response packet
D121: First response packet
D122: Second response packet
S11: First packet communication step
S12: Second packet communication step
S13: Third packet communication step

1. A control packet transmission system that mutually transmits a control packet storing control information between a request side device that requests control and a response side device that responds to a control request from the request side device, the request side device and the response side device configuring a client server system that performs wireless communication via a wireless communication path and uses Multi Path-Transmission Control Protocol (MP-TCP), the control packet transmission system comprising:
the request side device that transmits a plurality of first request packets indicative of a request to the response side device in the control packet to the response side device via at least one or more of the wireless communication paths; and
the response side device that transmits a plurality of first response packets indicative of a response to the first request packet in the control packet to the request side device via at least one or more of the wireless communication paths when the first request packet transmitted by the request side device is received for the first time.

2. The control packet transmission system according to claim 1, wherein
the request side device transmits the plurality of first request packets indicative of a request for connection or disconnection to the response side device in the control packet to the response side device via at least two or more of the wireless communication paths,
the response side device transmits the plurality of first response packets to the request side device via at least any of the at least two or more of the wireless communication paths when the first request packet transmitted by the request side device is received for the first time, and
the at least two or more of the wireless communication paths establish connection or disconnection when the request side device receives the first response packet transmitted by the response side device for the first time.

3. The control packet transmission system according to claim 1, wherein
the wireless communication path used for transmitting the first request packet received for the first time by the response side device and the wireless communication path used for transmitting the first response packet received for the first time by the request side device are wireless communications compliant to different communication standards.

4. The control packet transmission system according to claim 1, wherein
the request side device executes transmission of the first request packet to the response side device a plurality of times before the plurality of first response packets transmitted at the second packet communication step are received for the first time.

5. A control packet transmission method that mutually transmits a control packet storing control information between a request side device that requests control and a response side device that responds to a control request from the request side device, the request side device and the response side device configuring a client server system that performs wireless communication via a wireless communication path and uses MP-TCP, the control packet transmission method comprising a computer executing:
a first packet communication step of transmitting a plurality of first request packets indicative of a request to the response side device in the control packet to the response side device via at least one or more of the wireless communication paths; and
a second packet communication step of transmitting a plurality of first response packets indicative of a response to the first request packet in the control packet to the request side device via at least one or more of the wireless communication paths when the response side device receives the first request packet transmitted at the first packet communication step for the first time.

6. A control packet transmission program for mutually transmitting a control packet storing control information between a request side device that requests control and a response side device that responds to a control request from the request side device, the request side device and the response side device configuring a client server system that performs wireless communication via a wireless communication path and uses MP-TCP, the control packet transmission program comprising a computer executing:
a first packet communication step of transmitting a plurality of first request packets indicative of a request to the response side device in the control packet to the response side device via at least one or more of the wireless communication paths; and
a second packet communication step of transmitting a plurality of first response packets indicative of a response to the first request packet in the control packet to the request side device via at least one or more of the wireless communication paths when the response side device receives the first request packet transmitted at the first packet communication step for the first time.
